(19) United States
(12) Patent Application Publication
(10) Pub. No.: US 2020/0005529 A1
(43) Pub. Date: Jan. 2, 2020

(54) SYSTEM, METHOD AND COMPUTER-ACCESSIBLE MEDIUM FOR DISPLAYING A THREE-DIMENSIONAL DIGITAL VERSION OF AN OBJECT

(71) Applicant: VIRTUAL DIAMOND BOUTIQUE INC., New York, NY (US)

(72) Inventor: Zack PERDUE, Holt, MI (US)

(73) Assignee: Virtual Diamond Boutique Inc., New York, NY (US)

(21) Appl. No.: 16/480,036

(22) PCT Filed: Jan. 23, 2018
(86) PCT No.: PCT/US2018/014885

§ 371 Date: Jul. 23, 2019

Related U.S. Application Data
(60) Provisional application No. 62/449,358, filed on Jan. 23, 2017.

(51) Int. Cl. G06T 17/00; H04N 13/264

(52) U.S. Cl. CPC G06T 17/00; G06T 2200/08; H04N 13/264

(57) ABSTRACT

Exemplary system, method and computer-accessible medium for generating a three-dimensional (3D) digital version of an object(s) can be provided, using which, for example, it is possible to receive a video(s) of the object(s), transcode the video(s) into a plurality of images, and generate the 3D digital version of the object(s) based on the plurality of images. The object(s) can be a diamond or a gemstone. The video(s) can be a 360 degree video of the object(s). The video(s) can be transcoded using a transcoding procedure(s), which can be utilized to decode and extract the plurality of images from the video(s). The plurality of images can be provided in a sequence based on the video(s).

### CROSS-REFERENCE TO RELATED APPLICATION(S)

This application relates to and claims priority from U.S. Patent Application No. 62/449,358, filed on Jan. 23, 2017, the entire disclosure of which is incorporated herein by reference.

### FIELD OF THE DISCLOSURE

The present disclosure relates generally to displaying an object, and more specifically, to exemplary embodiments of an exemplary system, method and computer-accessible medium for displaying a three-dimensional digital version of an object.

### BACKGROUND INFORMATION

Traditionally, when buying jewelry (e.g., diamond jewelry or other jewelry), shoppers would visit one or more local jewelers and review the available selection of jewelry. Shoppers can enquire about the quality of the diamond, and can inspect the jewelry before purchasing it. If the shopper is seeking to purchase a custom-made piece of jewelry, the shopper can physically inspect the diamonds ahead of time, and choose a specific diamond, or other gemstone, for the custom jewelry.

As e-commerce has expanded, the number of people purchasing jewelry online has also expanded. However, when a shopper purchases jewelry online, they are unable to inspect the diamond or gemstone prior to purchase. Generally, the shopper will select a particular diamond that has a certain cut, quality etc., and the website will provide a generated line drawing of what the diamond will look like (e.g., the shape, number of inclusions, etc.). Thus, the shopper has to purchase the diamond on faith, as the shopper can only inspect the diamond/jewelry after they have purchased it.

Thus, it may be beneficial to provide an exemplary system, method and computer-accessible medium for displaying a three-dimensional digital version of an object which can overcome at least some of the deficiencies described herein above.

### SUMMARY OF EXEMPLARY EMBODIMENTS

An exemplary system, method and computer-accessible medium for generating a three-dimensional (3D) digital version of an object(s) can be provided, which can include, for example, receiving a video(s) of the object(s), transcoding the video(s) into a plurality of images, and generating the 3D digital version of the object(s) based on the plurality of images. The object(s) can be a diamond or a gemstone. The video(s) can be a 360 degree video of the object(s). The video(s) can be transcoded using a transcoding procedure(s), which can be utilized to decode and extract the plurality of images from the video(s). The plurality of images can be provided in a sequence based on the video(s).

In certain exemplary embodiments of the present disclosure, the 3D digital version can be generated by iterating over the plurality of images or by stitching together the plurality of images. A particular number of the plurality of images can be removed before generating the 3D digital version of the object(s). The video(s) can be received over a network. The 3D digital version of the object(s) can be transmitted over a network to be viewed by a user.

In some exemplary embodiments of the present disclosure, the at least one video can be generated, for example, using a video camera and processor(s) associated therewith. The 3D digital version(s) can be stored in a cloud-based storage or in a local storage. The video(s) can include a top view and a side view of the object(s). The images can be cropped and or scaled to fit a particular resolution.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic diagram of an exemplary system for displaying a three-dimensional digital version of an object according to an exemplary embodiment of the present disclosure;

FIG. 2 is a further exemplary schematic diagram of the exemplary system/method for displaying a three-dimensional digital version of an object, which also has a flow diagram, according to another exemplary embodiment of the present disclosure;

FIG. 3 is an exemplary flow diagram of a method for generating a three-dimensional digital version of an object according to an exemplary embodiment of the present disclosure; and

FIG. 4 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The exemplary embodiments of the present disclosure may be further understood with reference to the following description and the related appended drawings. The exemplary embodiments of the present disclosure relate to a system, method and computer-accessible medium for displaying a three-dimensional (“3D”) digital version of an object. The exemplary system, method and computer-accessible medium will described herein below with reference to diamonds, however, the exemplary system, method and computer-accessible medium can be applied to other objects (e.g., the display of objects other than diamonds), for example, other gemstones. Exemplary gemstones can include, but are not limited to, jade, amethyst, azurite, bismuth, onyx, opal, sapphire, topaz, quartz, emerald, garnet, obsidian, ruby, spinel, tanzanite, turquoise and zircon.

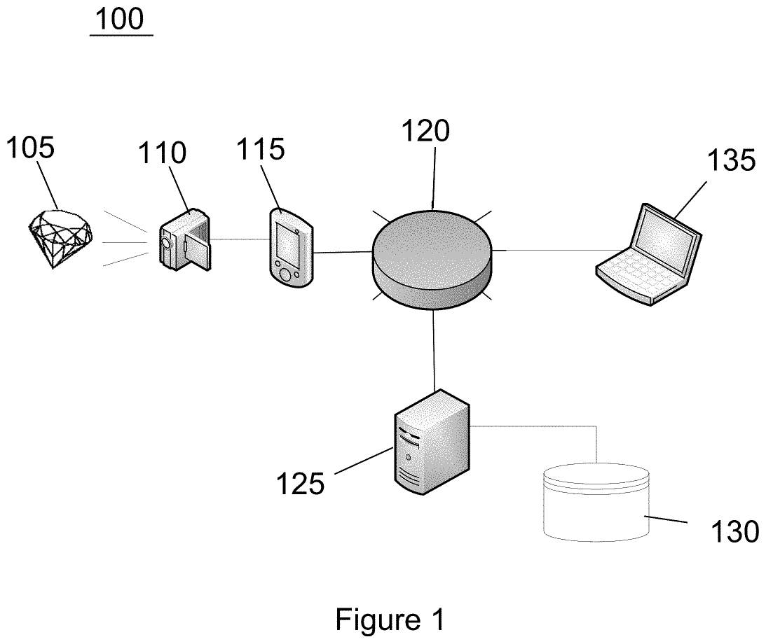

FIG. 1 shows a schematic diagram of the exemplary system/method 100 for displaying a three-dimensional digital version of an object (e.g., diamond 105) according to an exemplary embodiment of the present disclosure. For example, the exemplary system/method 100 can include a network 120, through which the multiple components of the exemplary system/method 100 can communicate. A device 115 can communicate with a camera 110 in order to generate a plurality of pictures or a video, of diamond 105. Exemplary devices 115 can include, but are not limited to, mobile devices (e.g., phones, tablets or laptops) or non-mobile devices (e.g., desktop computers). Camera 110 can be separate from device 116 (e.g., camera 110 can be a separate video or still camera). Alternatively, camera 110 can be embodied in device 115 (e.g., camera 115 can be part of a mobile device such as a mobile phone).

In order to generate a 3D digital version of diamond 105, the exemplary system/method 100, using device 115 and camera 110, can obtain a plurality of images and/or a video, of diamond 105. The images and/or video can be taken at many various angles related to diamond 105, such that a 3D digital version of diamond 105 is created, which can be viewed at any angle (e.g., side, top or bottom). Alternatively, single-side images and/or a video can be obtained of diamond 105 to generate a 3D digital side image of diamond 105. Once the images, or video(s), of diamond 105 are generated, they can be transmitted to a server 125, over network 120, for processing.

For example, after the images/video(s) are received by server 125, the images/video(s), can be processed into a 3D digital version by server 125 using an exemplary 3D digital version generating procedure, which will be described in more detail below. The 3D digital version can be stored in a database 130 to be viewed at a later date (e.g., by device 135).

A plurality of digital versions of different diamonds (or other gemstones) can be stored in database 130, which can be viewed by device 135. For example, device 135 can communicate with server 125, over network 120, in order to access the 3D digital diamonds which are stored in database 130. Device 135 can include mobile devices (e.g., phones, tablets and/or laptops) or non-mobile devices (e.g., desktop computers, or other computing devices that can access network 120). In order to view the different diamonds or gemstones, device 135 can request a specific diamond from server 125. Server 125 can then transmit the 3D digital version of the diamond 105 to device 135, which can be viewed at almost any angle depending the images, or video(s), which was taken of the diamond 105.

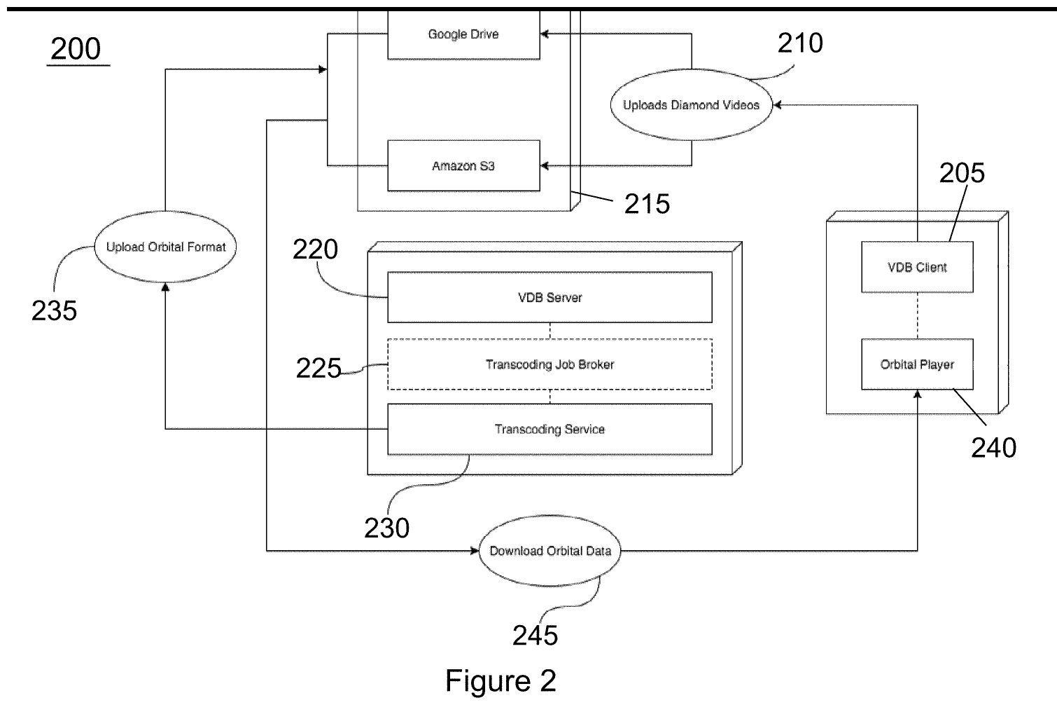

FIG. 2 shows a further exemplary schematic diagram of the exemplary system/method 200 for displaying the 3D digital version of an object according to an exemplary embodiment of the present disclosure. For example, VDB Client 205 (e.g., device 115 shown in FIG. 1) can utilize a mobile application or web-based user interface to upload one or more diamonds 210 (e.g., as a video or series of images) to an online (e.g., cloud-based) storage 215. For example, the user of the VDB Client 205 can add a video of diamond 210 to their account. The video file can then be uploaded to a cloud storage platform 215 to be transcoded at a later time. The video footage can be of a diamond positioned stationary in the center of a rotating platform, with a camera capturing 360 degrees of rotation of the diamond 210 in a series of images or a video. Exemplary cloud storage platforms 215 can include Google Drive or Amazon Simple Storage Service (“S3”), although other cloud storage platforms can be used.

After the images or video(s) has been uploaded to cloud storage platform 215, VDB Server 220 can receive a notification that a new diamond has been uploaded, which can be transcoded. This exemplary notification can be provided to the transcoding job broker 225. Transcoding job broker 225 can place a new transcoding job in a transcoding job queue. Transcoding job broker can then transcode the images, or video(s). Multiple jobs can be transcoded simultaneously.

In order to transcode the images/video(s), transcoding job broker 225 can use transcoding service 230. Transcoding service 230 can utilize various tools to transcode the images or video(s) (e.g., an open-source tool called FFMPEG) to decode and extract frames to be processed into the 3D digital version of the diamond.

For example, if a video is transcoded, a specific crop filter can be determined for each frame to convert the frame into a square. A scale filter can be determined to fit frames into a particular resolution (e.g., 600×600). The exemplary transcoding procedure can produce a series of images (e.g., in a jpg format). These images can be iterated over, or stitched, into a sequence, and a certain number of images can be removed to decrease the file size (e.g., every third image can be removed). The remaining images can be uploaded 235, in a particular format (e.g., an orbital format), back to the cloud storage platform 215. After the images are uploaded back into cloud storage platform 215, a diamond object in the database can be recorded as having a 3D digital version to be viewed at a later date by a user.

For example, a device (e.g., device 135 shown in FIG. 1) can utilize an orbital player 240 on the device to download orbital data 245 from cloud storage platform 215. The user of the device, viewing the 3D digital version of the diamond, can rotate the diamond in any direction (e.g., 360 degrees) to see what the real diamond would look like. In particular, orbital player 240 can be a canvas application written in JavaScript. Such exemplary application can facilitate a user to play picture frames as follows. First, picture frames from cloud storage platform 215 can be located for the specified diamond. Images can also be locally cached so that frames do not have to be re-downloaded when images change. When a first frame is downloaded, playback of the diamond can begin, which can be viewed by the user. The frames per second and intervals can also be determined in the following exemplary manner:

fps=framecount/(2*Math.PI); #frame count can be the total number of frames
filesfpsInterval=rotationconstant/fps; # rotation constant can default to 2300 but can be adjusted using a configurable variable.

According to certain exemplary embodiments of the present disclosure, each image of the diamond/gemstone can be digitally drawn on canvas as a 600×600 square. A loop can then be initiated to keep changing consecutive picture frames in a round-robin fashion.

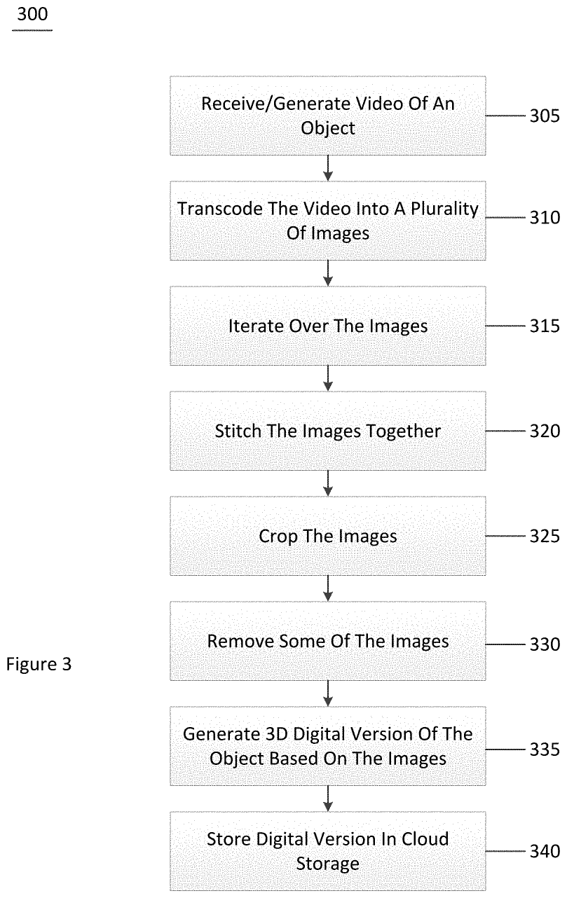

FIG. 3 shows an exemplary flow diagram of an exemplary method 300 for generating a 3D digital version of an object according to an exemplary embodiment of the present disclosure, which can be executed by, e.g., a computer processor. For example, at procedure 305, a video of an object can be generated or received. At procedure 310, the video can be transcoded into a plurality of images. The images can be iterated over at procedure 315, stitched together at procedure 320, and cropped at procedure 325. At procedure 330, some of the images can be removed. At procedure 335, a 3D digital version of the object can be generated based on the images, which can be stored in a cloud storage at procedure 340.

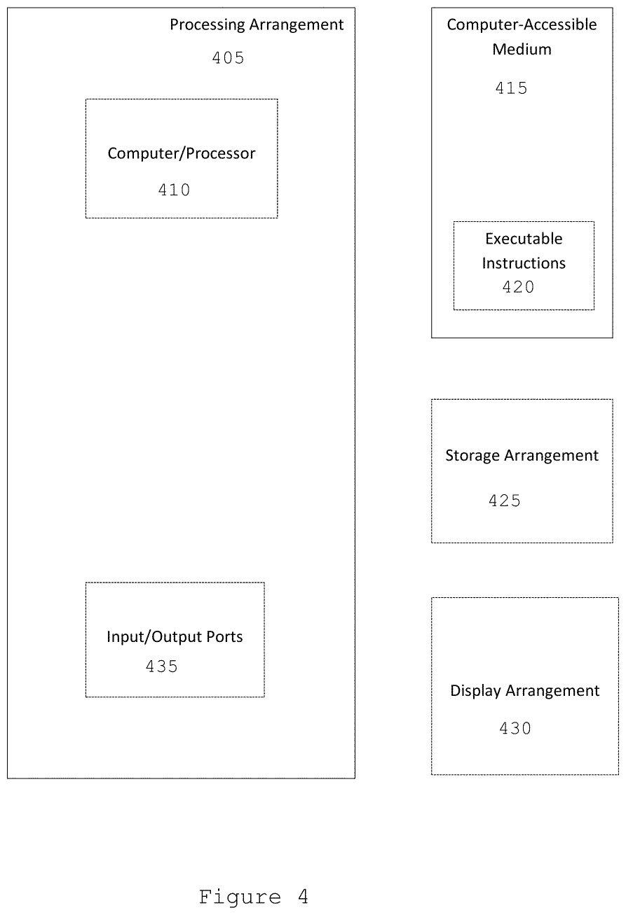

FIG. 4 shows a block diagram of an exemplary embodiment of a system according to the present disclosure. For example, exemplary procedures in accordance with the present disclosure described herein can be performed by a processing arrangement and/or a computing arrangement 405. Such processing/computing arrangement 405 can be, for example entirely or a part of, or include, but not limited to, a computer/processor 410 that can include, for example one or more microprocessors, and use instructions stored on a computer-accessible medium (e.g., RAM, ROM, hard drive, or other storage device).

As shown in FIG. 4, for example a computer-accessible medium 415 (e.g., as described herein above, a storage device such as a hard disk, floppy disk, memory stick, CD-ROM, RAM, ROM, etc., or a collection thereof) can be provided (e.g., in communication with the processing arrangement 405). The computer-accessible medium 415 can contain executable instructions 420 thereon. In addition or alternatively, a storage arrangement 425 can be provided separately from the computer-accessible medium 415, which can provide the instructions to the processing arrangement 405 so as to configure the processing arrangement to execute certain exemplary procedures, processes and methods, as described herein above, for example.

Further, the exemplary processing arrangement 405 can be provided with or include an input/output arrangement 435, which can include, for example a wired network, a wireless network, the internet, an intranet, a data collection probe, a sensor, etc. As shown in FIG. 4, the exemplary processing arrangement 405 can be in communication with an exemplary display arrangement 430, which, according to certain exemplary embodiments of the present disclosure, can be a touch-screen configured for inputting information to the processing arrangement in addition to outputting information from the processing arrangement, for example. Further, the exemplary display 430 and/or a storage arrangement 425 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A non-transitory computer-accessible medium having stored thereon computer-executable instructions for generating a three-dimensional (3D) digital version of at least one object, wherein, when a computer arrangement executes the instructions, the computer arrangement is configured to perform procedures comprising:
receiving at least one video of the at least one object;
transcoding the at least one video into a plurality of images; and
generating the 3D digital version of the at least one object based on the plurality of images.

2. The computer-accessible medium of claim 1, wherein the at least one object is a diamond or a gemstone.

3. The computer-accessible medium of claim 1, wherein the at least one video is a 360 degree video of the at least one object.

4. The computer-accessible medium of claim 1, wherein the computer arrangement is configured to transcode the at least one video using at least one transcoding procedure.

5. The computer-accessible medium of claim 4, wherein the computer arrangement is configured to utilize the transcoding procedure to decode and extract the plurality of images from the at least one video.

6. The computer-accessible medium of claim 1, wherein the plurality of images are provided in a sequence based on the at least one video.

7. The computer-accessible medium of claim 6, wherein the computer arrangement is configured to generate the 3D digital version by iterating over the plurality of images.

8. The computer-accessible medium of claim 1, wherein the computer arrangement is configured to generate the 3D digital version by stitching together the plurality of images.

9. The computer-accessible medium of claim 1, wherein the computer arrangement is further configured to remove a particular number of the plurality of images before generating the 3D digital version of the at least one object.

10. The computer-accessible medium of claim 1, wherein the at least one video is received over a network.

11. The computer-accessible medium of claim 1, wherein the 3D digital version of the at least one object is transmitted over a network to be viewed by a user.

12. The computer-accessible medium of claim 1, wherein the computer arrangement is further configured to generate the at least one video.

13. The computer-accessible medium of claim 1, wherein the computer arrangement is further configured to store the at least one 3D digital version in a cloud-based storage.

14. The computer-accessible medium of claim 1, wherein the at least one video includes a top view and a side view of the at least one object.

15. The computer-accessible medium of claim 1, wherein the computer arrangement is further configured to crop the images.

16. The computer-accessible medium of claim 1, wherein the computer arrangement is further configured to scale the images to fit or provide a particular resolution.

17. A system for generating a three-dimensional (3D) digital version of at least one object, comprising:
a computer hardware arrangement specifically configured to:
receive at least one video of the at least one object;
transcode the at least one video into a plurality of images; and
generate the 3D digital version of the at least one object based on the plurality of images.

18-32. (canceled)

33. A method for generating a three-dimensional (3D) digital version of at least one object, comprising:
receiving at least one video of the at least one object;
transcoding the at least one video into a plurality of images; and
using a specifically configured computer hardware arrangement, generating the 3D digital version of the at least one object based on the plurality of images.

34. The method of claim 33, wherein the at least one object is a diamond or a gemstone.

35-40. (canceled)

41. The method of claim 33, further comprising removing a particular number of the plurality of images before generating the 3D digital version of the at least one object.

42-48. (canceled)
